(19) United States
(12) Patent Application Publication
(10) Pub. No.: US 2006/0279256 A1
(43) Pub. Date: Dec. 14, 2006

(54) Power management system for multi-function battery-operated device

(75) Inventor: Michail Bletsas, Brookline, MA (US)

Correspondence Address: CHARLES G. CALL, 68 HORSE POND ROAD, WEST YARMOUTH, MA, 02673-2516, US

(73) Assignee: Media Lab, Cambridge, MA (US)

(21) Appl. No.: 11/149,844

(22) Filed: Jun. 10, 2005

(51) Int. Cl. H02J 7/00

(52) U.S. Cl. 320/128

(57) ABSTRACT

Methods and apparatus for controlling the execution of individual functions performed by a multi-function battery-powered electronic device, such a cellular telephone. The device user assigns priority values to each function. When the execution of a function is requested, the system determines whether or not the current battery charge level is greater than a threshold level determined by the requested function's assigned priority. If the battery level is too low, the user is alerted with an ignorable warning. Priority levels can be assigned to individual entries in a “phone book” to discourage conversations with low priority parties in order to conserve the battery to permit later calls to or from high priority numbers.

### FIELD OF THE INVENTION

This invention relates to methods and apparatus for controlling energy consumption in a multi-function battery operated device.

### BACKGROUND AND SUMMARY OF THE INVENTION

Battery powered portable electronic devices are typically programmable and can perform many different tasks. A newer cellular phone may be used not only for telephone calls but also to play music, take pictures, browse the Web, and play electronic games. A laptop computer can perform conventional tasks like word processing and also be used to link to other computers and to provide entertainment. A PDA (Personal Digital Assistant) can be used to provide easy access to commonly needed information like phone numbers, addresses, and appointments, but may also be used to play music or games.

Unfortunately, using such devices to provide entertainment or other less important functions may deplete the battery to the point where critical tasks can no longer be performed. For example, a teenager can use a cellular phone to play electronic games, or listen to music, and thereafter be unable to place or receive important phone calls. A traveler may use a laptop computer to watch a DVD movie and thereby deplete the battery so much that the computer can't be used to review important stored data or to send and receive email.

It is accordingly a leading object of the present invention to help ensure that enough battery power will be available when needed to perform high priority tasks by preventing lower priority tasks from excessively draining the battery.

In a principle aspect, the present invention takes the form of methods and apparatus for controlling energy consumed by a multi-function electronic device operated by a battery. In accordance with the invention, a threshold battery charge level may be associated with each of the different functions performed by the device. When one of these functions is requested, a comparison is performed between current charge level of the battery and the threshold charge level value associated with the requested function, and the execution of the requested function is inhibited if the current battery level is too low.

The threshold battery charge level associated with performable function is preferably established by first storing a default value for each function and thereafter accepting and storing changes to these priority values from a user, A threshold charge level associated with each given one of the functions may be derived from the corresponding stored priority value associated with that function. The execution of a requested function is preferably controlled by first issuing a warning to the user if the current battery level is less than said threshold level associated with the requested function. The warning may be a visual message, an audio alert, or both. The battery threshold level that is associated with each performable function may be adjusted to reflect the estimated energy that would be consumed by the execution of that function.

The present invention may be used to particular advantage to control the functions performed by a communication device such as a cellular phone that is powered by a battery. In this application, a priority value may be associated with each of a plurality of remotely located devices with which said communication device can be connected, and a threshold battery level may be derived from the associated priority value assigned to each remote device. When a request to establish an operative communication link with a particular remote devices, such as an outbound or incoming call connection with a particular telephone number, the system inhibits the establishment of that link if the current charge level of said battery is less than the threshold battery level value associated with the selected remote device. Thus calls to or from certain numbers may be discouraged when the battery is low to make sure that sufficient battery power is available later for emergency calls.

The invention thus helps insure that power will be available for important tasks by assigning an energy priority index to every task that the battery-operated device can perform. The user matches those priorities to his or her perception of importance of the various tasks (relative to each other) and the device's operating system ensures that as the battery drains, more important tasks can be performed for longer periods of time.

These and other features and advantages of the invention may be more clearly understood by considering the following detailed description.

### BRIEF DESCRIPTION OF THE DRAWINGS

In the detailed description which follows, frequent reference will be made to the attached drawings, in which:

FIG. 1 is a block diagram illustrating the principal functional components used to implement a preferred embodiment of the invention;

FIG. 2 is a flow chart illustrating the manner in which the user of a battery operated device assigns different priorities to different functions performed by the device; and

FIG. 3 is a flow chart illustrating the manner in which the device prevents or discourages the use of the device to perform lower priority tasks that would excessively deplete the device's battery level.

### DETAILED DESCRIPTION

The invention may be used to particular advantage to control the operation of a cellular telephone so that sufficient battery power will be available when needed to place and receive critical telephone calls. It is to be understood, however, that the principles of the invention are generally applicable to any multi-function, battery-operated device.

In a simple cellular telephone application, the user assigns certain numbers in the “phone book” directory database a “high priority.” When the battery has discharged below a threshold charge level (e.g. 10% of full charge), the phone allows calls to and from only the specified high priority numbers. Any attempt to place a call to any other number, or to perform some other function such as playing an electronic game, causes a warning message to be displayed, advising the user that the battery level is low. The user is given the opportunity to override the warning and perform the selected function, but does so with the knowledge that the requested operation may make it impossible to send or receive high priority calls later if the battery becomes totally discharged. Incoming calls from high priority numbers are permitted when the battery level is below the threshold, but all other incoming numbers are forwarded to the voicemail system.

The system periodically checks to determine whether the battery level remains above the threshold when the user is using the cellular phone to handle an active call or perform some other function. If the user is talking with a non high-priority number when the battery level falls below the threshold level, an audible alert, such as a soft beep, is sounded, and the phone displays a visible text message such as “battery is getting low, call will be disconnected in 30 sec, OK?” The user can accept the message and hang up within the next 30 sec, or override the warning and keep talking.

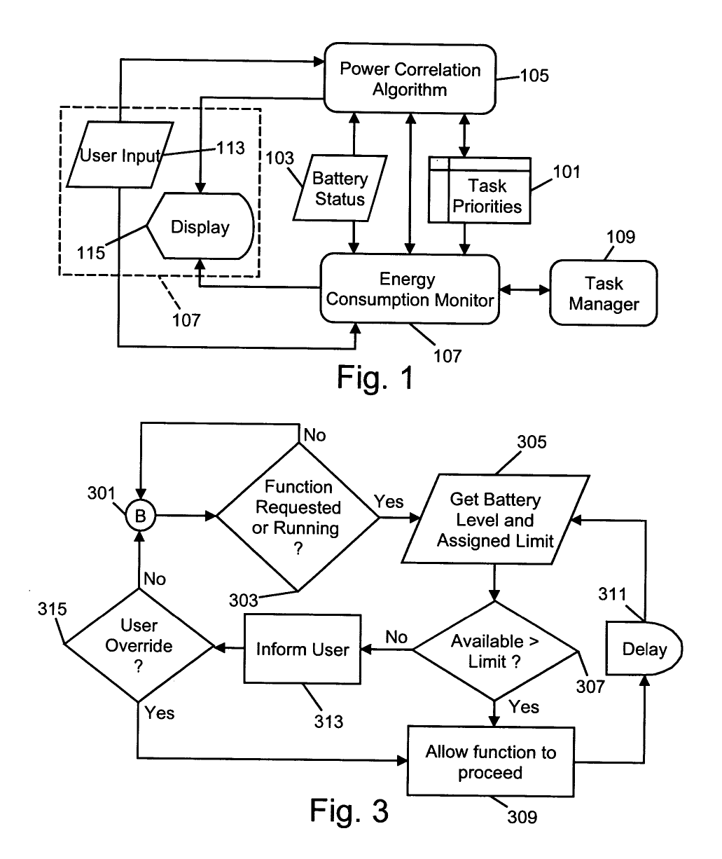

The main components of a system implementing the invention are shown in FIG. 1. These components include:

Means for storing priority values as indicated at 101. A stored priority value is associated with each task or type of task the battery powered device performs. In addition, if the device provides communications with different remote locations, each location (such as a remote telephone number in a phone book) may be associated with an assigned priority value.

Means for determining the current status of the battery as indicated at 103.

Means for correlating the priority value assigned to each task with a battery life threshold level as indicated at 105. The algorithm determines the battery level which must exist to permit each task to be performed without at least generating a warning to the user.

An energy consumption monitor indicated at 107 that ensures that running tasks don't drain the battery below the limit that is assigned to them (according to their energy priority index). The consumption monitor prohibits tasks from executing if the current battery level falls below the threshold level determined by the correlation algorithm 105, and also generates a warning if the battery level falls below the threshold when the task is being performed. The monitor issues advisory warnings to the user when selected tasks should not be executed or should be discontinued, but may permit the user to override the warning and go forward with the task on demand.

The task manager 109 notifies the monitor 107 whenever a new task is invoked, and receives a response from the monitor indicating whether or not the task shall be allowed to execute. The task manager 109 also responds to commands from the monitor 107 which indicate that a running task should be terminated to preserve battery energy. The task manager 109 calls upon operating system functions to launch and terminate programs. Typically, it is the responsibility of the executing program itself to gracefully terminate operations by saving data to persistent storage etc. when it receives a termination command from the operating system.

A user interface indicated at 110 consisting of an input device (such as a cellular phone keypad) 113 and an output device (such as a cellular phone display panel) 115. The user interface 110 permits the user to:

(a) view and edit the priority values (e.g. the battery limits) associated with at least the principle functions or types of functions performed by the battery powered device;

(b) issues advisory warnings when the system prohibits or discourages the performance of functions when the battery level falls below the threshold assigned to those functions, and

(c) accept commands to allow the user to override or select optional alternative functions when a warning is issued.

The details of the implementation of each of the foregoing major components will depend on the battery powered device's design and intended functionality. The general principles which need to be taken into account are described below:

The energy priority index data seen at 101 is the main addition to a device's data structures. It is added for both application programs and/or data, such as phone book entries. For example, in the case of a cellular phone including a built in “phone book” for dialing outgoing calls and for displaying phone book information identifying incoming callers, each of the applications (major functions) the device can perform, and every one of the address book entries (which also defines a “function” or task as those terms are used here) has it's own energy priority index. The priority value assigned to each function may take the form of a single number, several numbers indicating different thresholds for different purposes, and may take the form of one or more fields in a structured data record associated with the task or function. In the case of programs, the index can be stored within the program's executable image or it can be stored in the file system's directory entries or in one or more metadata files. In the case of data stored in structured records (like phonebook entries), an extra field or fields can be added to the structured records.

By way of example, each telephone book entry may be assigned a first number indicating the priority assigned to incoming calls from that number and a second number indicating the priority assigned to outgoing calls to that number. Each of these numbers (and indeed all priority numbers stored in the task priority storage unit 101) may be initially assigned a default priority number which remains at that default setting unless altered by the user. Thus, a user may assign a higher priority to a limited number of selected tasks so that all other tasks remain at a lower priority. Or, the user may assign low priority numbers to tasks or functions such as games or entertainment functions the performance of which should be discouraged whenever the battery level is low.

As an example, a particular user may wish to identify a limited number of phone numbers in the phone book which are to enjoy a high priority, leave most or the rest at a preassigned default level, and assign a still lower priority to a few numbers with which only low priority conversations are likely. The same user may wish to assign a very low priority to programs which provide entertainment, such as electronic games, but a relatively high priority to the Web browser program which the user may use to check email. Note that, if the device employs a built in Web browser that permits a set of “favorite” URLs to be stored for easy reference, high or low priority level values may be associated with those URLs as well, and the ability to designate an energy priority level could be included as part of the book-marking mechanism used to select and store “favorite” URLs.

To simplify the setting of priority levels, the system preferably provides a mechanism for displaying a list of all functions (including phone book entries and the like), or a list of all functions which are still at the default level, or a list of all high priority functions, or a list of all low priority functions, and so on, to enable the user to more easily identify functions whose priority level should be altered from its current setting. In addition, the user may be permitted to globally set the priority level of all functions, or all functions of a particular type, at the same time.

Stored values which are made visible to the user may be presented as numeric values; for example, a number between “0” and “9” indicates increasing priority. Alternatively, priority values which are displayed and edited by the user may be represented by labels such as “very low,” “low,” “average,” “high,” and “very high.” Alternatively, the priority value may be represented by a the height or width of a variable length bar, a gauge setting, a symbol that directly indicates a battery level below which the task should not operate, or some other graphic representation that is easy to understand coupled with a mechanism that makes the value represented by the symbol easy to adjust. The “priority” value typically indicates the importance the user assigns to the task. For most devices and applications, the user should be given the opportunity to adjust a value that directly indicates the battery level below which the performance of a particular function should be prevented or discouraged.

In other applications, it may be preferable to display a battery level threshold as a time duration; for example, in a cellular phone, each task may be assigned a value that indicates the how much “talking time” must be available from the battery before the particular task is allowed to execute without generating a warning.

The selection of the particular metaphor to be used to assign different priorities to different tasks will depend on the character of the particular device and the different functions it performs. In all cases, however, the method chose for displaying and editing priority values should provide a simple, intuitive user interface that enables the user to best achieve the desired result: insuring that adequate power will be available to execute the highest priority tasks when they're needed.

The power correlation algorithm can be implemented in a variety of ways. Possible options range from simple one-to-one mapping between a user assigned priority indexes and remaining battery capacity percentages; that is, a priority can be set to a number between 1 and 100, where a setting of “10” for a particular task means that the task can run as long as the battery level remains above 10%. Alternatively, a lookup table may be used to map priorities to battery percentages. For example, a “LOW” priority level setting for a given task may set the battery level which must exist to execute that task at 25%, whereas a “MEDIUM” priority task is allowed to execute if the battery level exceeds 10%, and a “HIGH” priority task is always allowed to execute (i.e. has a 0% threshold). Alternatively, a mathematical function may be performed to derive a battery threshold level from a priority level set by or accepted by the user. These lookup tables or correlation functions may take into consideration the relation between the various priorities, differences in the rate at which different tasks consume energy, or timing constraints entered by the user. For example, always ensure that there are 10 minutes of talk time before allowing the music player to play a song.

Note also that, where it is possible to estimate that amount of energy that a particular task will consume, the user may specify a priority value that indicates how much battery life should remain after the task is executed. Thus, for example, a laptop computer that includes a DVD movie player program may issue a warning if playing a selected video file (whose size is known from the file system) can be expected to deplete the battery below a predetermined threshold. In this way, the user may avoid launching tasks that will be unable to complete before the battery level falls below a designated threshold value. The power correlation algorithm 105 may thus establish a battery threshold value for a particular task which takes into account the amount of energy that task can be expected to consume. That is, the calculated battery threshold value should be greater than the level which is established or implied from the user setting (which indicates how much energy should be left for higher priority tasks after the given task has completed its execution). The amount of energy typically consumed by a given program, function, or data type may be adaptively learned; for example, the resources consumed by an application (processor cycles, disk I/O, etc.) during prior executions may be measured, and from these measurements, an estimate of the application's energy consumption may be created and stored for later reference.

The energy consumption monitor 107 uses the data from the power correlation algorithm 105 as well as the battery status indicator 103, as well as the information about the active task in the task priority store 101 (which may include data from which the amount of energy which a task may consume can be determined). Before a task is started, the operating system consults the energy consumption monitor 107 to determine whether the current battery status is within the task's limits (as calculated by the power correlation algorithm 105) and allows the function to proceed or blocks it with an optional notification via the user interface 111.

While tasks are in progress the energy consumption monitor 107 is periodically checking that the executing tasks stay within their assigned battery limits. If the battery level falls below the limit for a specific running function, then the function is either automatically terminated, or the user is notified that the action will be terminated and is given the option to act, accepting or preventing the termination.

In some cases, the operating system may perform operations which can be expected to consume a significant quantity of energy. For example, if program executing on a laptop computer requests the operating system to open a very large file, a calculation can be performed to determine whether the requested function is likely to reduce the battery level below a predetermined threshold. Ordinarily, functions requested by the operating system in aid of the execution of a user requested task will be assigned the same priority level as the task they support; however, some tasks, such as automated back routines, may have a high priority assigned by the operating system administrator (rather than the user), while other tasks, such as updating resident software, may be assigned a low priority so that execution can be deferred until a time when the battery is more fully charged.

The user interface 111 is the component that allows the device's user to manipulate the battery limits of the various tasks as well as inform the user about actions that the system is taking based on current battery status and allow the user to control these actions on a per case or general basis. As noted above, implementation specifics are heavily device dependent since battery operated devices differ radically in their user interface facilities, in the kinds of functions they may perform, the operating system facilities that are available, and the nature of the battery supply to be conserved.

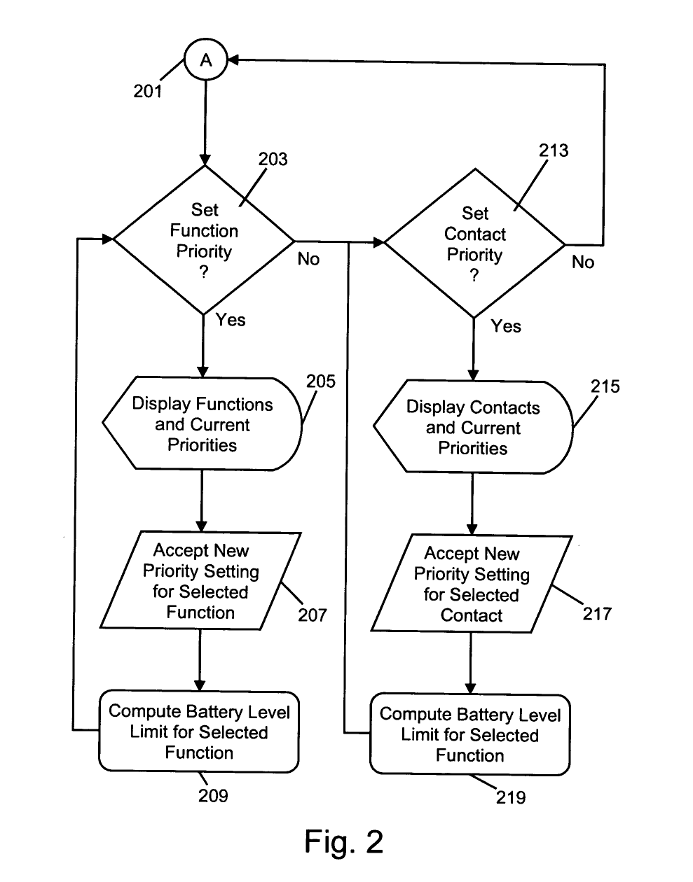

FIG. 2 shows an illustrative flowchart describing the steps performed when using the user interface 111 to set the priority levels for program functions available in a cellular telephone and to also set the priority levels for individual contact telephone numbers in the device's “phone book” directory. When the user selects the option to “Set Energy Priority Levels” from an available system menu, the routine is entered at A as indicated at 201. The user is then asked if he or she wishes to set the priority level for functions at 203. If answered in the affirmative, the user is then shown a list of available functions (e.g. “Listen to music,”, “Play a game,” “Take pictures,” etc.) at 205. The current priority setting is displayed for each function. The user may then change the priority setting for a selected function at 207, and the system then executes the correlation algorithm (seen at 105 in FIG. 1) to compute a new threshold level for the selected function as indicated at 209. The process then returns to 203 and asks the user if the priority level for another function is to be edited.

If not, the user is asked whether or not the priority level for one or more contacts listed in the phone book is be changed at 213. If the user responds in the affirmative, a list of current priority settings for persons in the phone book (which may be listed alphabetically, or be category) is displayed at 215. The user may then specify a new priority level of an individual phone number, or for a displayed category of phone numbers (e.g. “work,” “family,” “friends,” or “emergency”). Note that the different categories may assign different default priority levels to contacts in different categories, with contacts in the “emergency” category being assigned the highest priority, “family” members having the second highest priority, “work” contacts a lower priority, and the lowest priority being assigned to “friends,” with the user being able to globally change the priority level assigned to all contacts within a selected group.

The energy consumption monitor seen at 107 in FIG. 1 may be implemented by the process illustrated in the flowchart of FIG. 3.

Beginning at entry point “B” seen at 301, the process performs the test at 303 to continuously await the receipt of a function request from the device's supervisory, menu-driven control program and/or the operating system. When the user (or the operating system) requests permission to launch a new function at 303, the battery status monitor (at 103 in FIG. 1) and the task priority data (at 101 in FIG. 1) are retrieved at 305. If the assigned battery level limit for the requested function has not already been calculated and stored at 101 by the correlation algorithm 105, the correlation is performed at this time. Either way, the step 305 supplies the current battery level and the threshold level values so that, at step 307, a test can be performed to determine whether sufficient battery energy exists to permit the requested task to execute. If the task is allowed to proceed as indicated at 309, the test is repeated after an appropriate delay interval indicated at 311.

If the test at 307 indicates that the battery level is below the threshold established for the requested (or currently running) function, a warning is issued to the user as seen at 313 which typically takes the form of both a repeating audio alert and a displayed message. The user responds as shown at 315 with an indication of whether or not the warning should be ignored so that a newly requested function will be permitted to launch notwithstanding the low battery condition. A running process may be allowed to continue to execute if the user fails to respond to the warning, but the warning will be repeated after the delay 311 until the user voluntarily terminates the running process or overrides the warning condition. If the user does not override the warning issued at 313, the test at 315 returns control to 301 where the process again awaits a new function request.

Since we are using a cell phone as an example we used the term “call” in the flowchart. It should be noted that the same basic flowchart applies on every possible task that the battery-operated device can perform, whether that task is a communications session or other kind of functionality (personal information management, entertainment, etc.) so the term “call” is interchangeable with the term “task” in the above flowchart.

### CONCLUSION

It is to be understood that the methods and apparatus which have been described above are merely illustrative applications of the principles of the invention. Numerous modifications may be made by those skilled in the art without departing from the true spirit and scope of the invention.

What is claimed is:

1. A method for controlling energy consumption by an electronic device operated by a battery and capable of performing a plurality of different functions, said method comprising, in combination, the steps of:
establishing a threshold battery level associated with each of said functions,
accepting a request to execute a selected one of said functions,
determining the current charge level of said battery,
performing a comparison between said current charge level with the threshold level associated with said selected one of said functions, and
controlling the execution of said selected one of said functions in response to said comparison.

2. A method for controlling energy consumption by an electronic device as set forth in claim 1 wherein said step of establishing a threshold battery level associated with each of said functions comprises the substeps of:
accepting and storing priority values from a user of said device, each of said priority values being associated with one or more of said functions specified by said user, and
deriving the threshold level associated with each given one of said functions from the corresponding stored priority value associated with said given one of said functions.

3. A method for controlling energy consumption by an electronic device as set forth in claim 2 wherein said step of controlling the execution of said selected one of said processes includes the substep of:
issuing a warning to the current user of said device if said comparison indicates that said current charge level is less than said threshold level associated with said selected one of said functions.

4. A method for controlling energy consumption by an electronic device as set forth in claim 3 further including the substep of accepting an instruction from said current user in response to said warning that indicates whether said selected one of said functions should be executed.

5. A method for controlling energy consumption by an electronic device as set forth in claim 4 wherein said warning is a visual warning indicative of a low battery condition.

6. A method for controlling energy consumption by an electronic device as set forth in claim 5 wherein said warning further includes an audible warning.

7. A method for controlling energy consumption by an electronic device as set forth in claim 2 wherein said substep of deriving the threshold charge level associated with each given one of said functions from the corresponding stored priority value associated with said given one of said functions includes varying said threshold charge level to reflect the estimated energy that would be consumed by the execution of said selected one of said functions.

8. A programmable electronic device comprising, in combination,
a battery for providing operating power to said device,
a processor for executing a plurality of different programmed functions,
means for establishing a threshold battery charge level value for each given one of said functions,
means for accepting instructions from said user to alter said threshold battery charge level values for selected ones of said functions,
and means for inhibiting the execution by said processor of those functions having an associated threshold battery charge level value which is less than the current charge level of said battery.

9. A programmable electronic device as set forth in claim 8 wherein said means for establishing a threshold battery charge level vale for each given one of said functions comprises associated with each of said functions comprises:
means for displaying an identification of said given one of said functions together with an indication of a priority value currently associated with said given one of said functions,
means for accepting an editing command from said user to alter said priority value currently associated with said given one of said functions, and
means for thereafter deriving the threshold battery charge level value for said given one of said functions from said priority value associated with said given one of said functions.

10. A programmable electronic device as set forth in claim 8 wherein said means for inhibiting the execution by said processor of those functions having an associated threshold battery charge level value which is less than the current charge level of said battery includes means for issuing a warning to said user indicative of a low current charge level of said battery.

11. A programmable electronic device as set forth in claim 10 further including means for accepting an instruction from said user for initiating or preventing said execution after said alarm is issued.

12. A programmable electronic device as set forth in claim 8 wherein said means for inhibiting the execution by said processor of those functions having an associated threshold battery charge level value which is less than the current charge level of said battery comprises, in combination:
means for accepting an instruction to execute a requested function, and
means for issuing a warning if the current charge level of said battery is less than the threshold battery charge level associated with said requested function.

13. A programmable electronic device as set forth in claim 12 further including means for controlling the execution of said requested function in response to an instruction accepted from the user of said device after said warning is issued.

14. A communication device comprising, in combination,
a battery for providing electrical energy for operating said communication device,
means for storing the identification of a plurality of remotely located devices with which said communication device can be connected,
means for establishing a threshold battery level value associated with each of said remotely located devices,
means for accepting a request to establish an operative communication link between said communication device and a selected one of said remotely located devices, and
means for inhibiting the establishment of said operative communication link if the current charge level of said battery is less than the threshold battery level value associated with said selected one of said remotely located devices.

15. A communication device as set forth in claim 14 wherein said communication device is a cellular telephone.

16. A communication device as set forth in claim 15 wherein said means for storing the identification of a plurality of remotely located devices includes means for storing telephone book data containing a plurality of different telephone numbers for said remotely located devices.

17. A communication device as set forth in claim 15 wherein said cellular telephone is capable of performing a plurality of additional functions at least one of which is selected from a group comprising: (a) performing an electronic game; (b) reproducing music; and (c) capturing digital images and wherein said cellular telephone further includes means for storing a priority value associated with each of said additional functions and means for inhibiting the execution of a requested one of said functions when a battery threshold level derived form the priority value associated with said requested one of said functions is greater than the current charge level of said battery.

18. A communication device as set forth in claim 14 wherein said means for inhibiting the establishment of said operative communication link includes means for issuing a warning to said user indicative of a low current charge level of said battery.

19. A communication device as set forth in claim 18 further including means for accepting an instruction from said user for establishing said connection after said alarm is issued.
